(19) United States
(12) Patent Application Publication
(10) Pub. No.: US 2018/0333982 A1
(43) Pub. Date: Nov. 22, 2018

(54) Envelope Form and Method for Processing

(71) Applicants: Christopher S. Lindsay, Rochester, NH (US); Gary J. Lindsay, Dover, NH (US); Jason Bryant, Eliot, ME (US)

(72) Inventors: Christopher S. Lindsay, Rochester, NH (US); Gary J. Lindsay, Dover, NH (US); Jason Bryant, Eliot, ME (US)

(21) Appl. No.: 15/982,168

(22) Filed: May 17, 2018

Related U.S. Application Data
(60) Provisional application No. 62/507,488, filed on May 17, 2017.

(51) Int. Cl. B43M 5/04; B65D 27/16

(52) U.S. Cl. CPC B43M 5/047; B31B 2150/001; B65D 27/16

(57) ABSTRACT

A flat mailing envelope form for encapsulating an insert by an automated paper folding machine, includes a rectangular front panel with a seal flap fold edge, a bottom fold edge opposite the seal flap fold edge, a first side fold edge, and a second side fold edge opposite the first side edge. A back panel extends from the front panel bottom fold edge includes a back panel seal cohesive region, a first wing cohesive region, and a second wing cohesive region. A seal flap extends from the front panel seal flap fold edge includes a seal flap cohesive region configured to mate with the back panel seal cohesive region. First and second wings with cohesive regions extend from the front panel.

### CROSS-REFERENCE TO RELATED APPLICATIONS

This application claims the benefit of U.S. Provisional Patent Application Ser. No. 62/507,488, filed May 17, 2017 and entitled “Envelope Form and Method for Processing,” which is incorporated by reference herein in its entirety.

### FIELD OF THE INVENTION

The present invention relates to document processing, and more particularly, is related to a machine processed paper envelope.

### BACKGROUND OF THE INVENTION

Document processing machines may prepare single or multi page documents and insert the prepared documents into envelopes, which may be printed and sealed. A typical document processing device may be configured to handle multiple sizes and types of envelopes corresponding to different sized document paper stock. Similarly, different envelopes may be used for documents with different page counts. In addition to or instead of using pre-made envelopes, such document processing machines may use flat envelope forms, which are folded by the machines into envelopes to receive the documents. The envelopes may be sealed using adhesives, for example, water activated (remoistenable) adhesives.

FIG. 1 shows an example of a business envelope 100. The business envelope 100 may formed from a single sheet of paper, having a first side flap 110 folded at a first side fold 115 and a second side flap 120 folded at a second side fold 125. A bottom flap 130 (or back) is folded at a bottom fold 135, so that a first portion of the bottom flap 130 overlaps the first side flap 110 at a first seam 116, and a second portion of the bottom flap overlaps the second side flap 120 at a second seam 126. The first seam 116 and the second seam 126 are typically sealed with an adhesive applied at an overlapping region 127. The side folds 110, 120 and bottom flap 130 are disposed opposite a front panel 140, and an opening 150, or throat, between the front panel 140 and the bottom flap 130 provides access for contents of the envelope 100, for example a document, to be inserted into an interior portion of the envelope 100. A seal flap 160 extends from the throat of the front panel 140, and may be folded at a seal flap fold 165 such that a seal portion 170 of the seal flap 160 overlays the bottom flap 130 and/or the side flaps 110, 120, such that any sealing adhesive will not come in contact with the throat 150 or the contents of the envelope 100.

A point of failure commonly found in folder/inserters (“envelope stuffers”) where the envelope is staged and open so its contents, for example, a folded set, may be inserted. Further, in order to facilitate handling of different sized documents, envelopes and/or envelope forms, document processing machines may become increasingly complex. For example, each size and/or type of envelope stock and/or envelope form may require separate storage areas as well as feeding, folding, stuffing, and sealing mechanisms to accommodate them. In addition, machinery for handling water activated adhesives may require frequent servicing. Therefore, there is a need in the industry to address one or more of these shortcomings.

### SUMMARY OF THE INVENTION

Embodiments of the present invention provide an envelope form and a method for processing the envelope form. Briefly described, the present invention is directed to a flat mailing envelope form for encapsulating an insert by an automated paper folding machine, includes a rectangular front panel with a seal flap fold edge, a bottom fold edge opposite the seal flap fold edge, a first side fold edge, and a second side fold edge opposite the first side edge. A back panel extends from the front panel bottom fold edge includes a back panel seal cohesive region, a first wing cohesive region, and a second wing cohesive region. A seal flap extends from the front panel seal flap fold edge includes a seal flap cohesive region configured to mate with the back panel seal cohesive region. First and second wings with cohesive regions extend from the front panel.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a schematic diagram showing a prior art business envelope.

FIG. 2 shows an inside view of a first embodiment of an envelope form.

FIG. 3 shows an outside view of the first embodiment of the envelope form of FIG. 2.

FIG. 4A is a simplified drawing of the first embodiment of FIG. 2 before folding.

FIG. 4B shows the envelope form after a first folding operation.

FIG. 4C shows the envelope form after a second and third folding operation.

FIG. 4D shows the finished envelope after a fourth folding operation of the envelope form.

FIG. 5 is a schematic diagram illustrating an example of a system for controlling machinery to manipulate the envelope form.

FIG. 6 is a flowchart of an exemplary method for using an envelope form.

### DETAILED DESCRIPTION

The following definitions are useful for interpreting terms applied to features of the embodiments disclosed herein, and are meant only to define elements within the disclosure.

As used within this disclosure, “cohesive” refers to a substantially dry adhesive that is applied to two separate regions of an envelope, for example a first cohesive region and a second cohesive region that form a bond when brought the first cohesive region is brought into physical contact with the second cohesive region, for example in the presence of applied pressure. A cohesive may be distinguished from an adhesive agent where the adhesive agent may be applied to only one of two surfaces to be bonded.

As used within this disclosure, “envelope form” refers to an unfolded or partially folded sheet of material that may have an adhesive applied to it. Once the envelope form is partially or fully folded may be referred to as an “envelope,” and is given a different reference number.

As used within this disclosure, “substantially” means “very nearly,” or to within ordinary manufacturing tolerances.

Reference will now be made in detail to embodiments of the present invention, examples of which are illustrated in the accompanying drawings. Wherever possible, the same reference numbers are used in the drawings and the description to refer to the same or like parts.

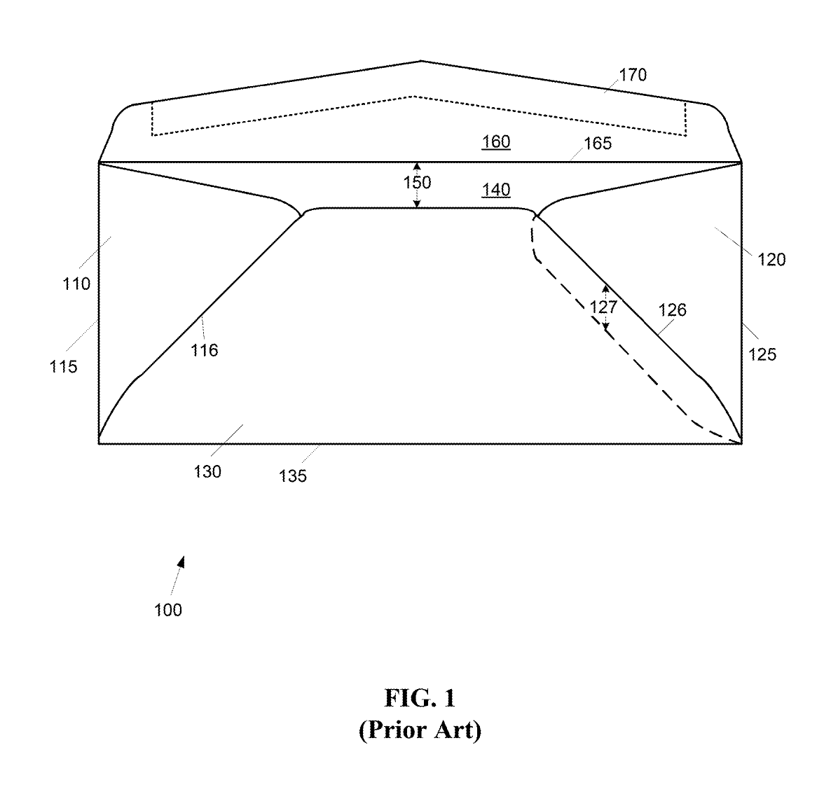

Exemplary embodiments disclosed herein involve an unfinished envelope to be folded and sealed around a payload or insert, for example, a document having a variable range of surface area and widths by an in-line document processing machine. A first embodiment of an envelope form 200 may be die cut and pre-glued, for example, using a cohesive. Under the first embodiment, the general shape of the die cut unfinished envelope form 200 may be in similar to the side seam construction used in manufacturing of traditional envelopes 100 (FIG. 1). The unfinished envelope form 200 may be loaded flat and unfolded into a document processing machine for filling, folding, and sealing.

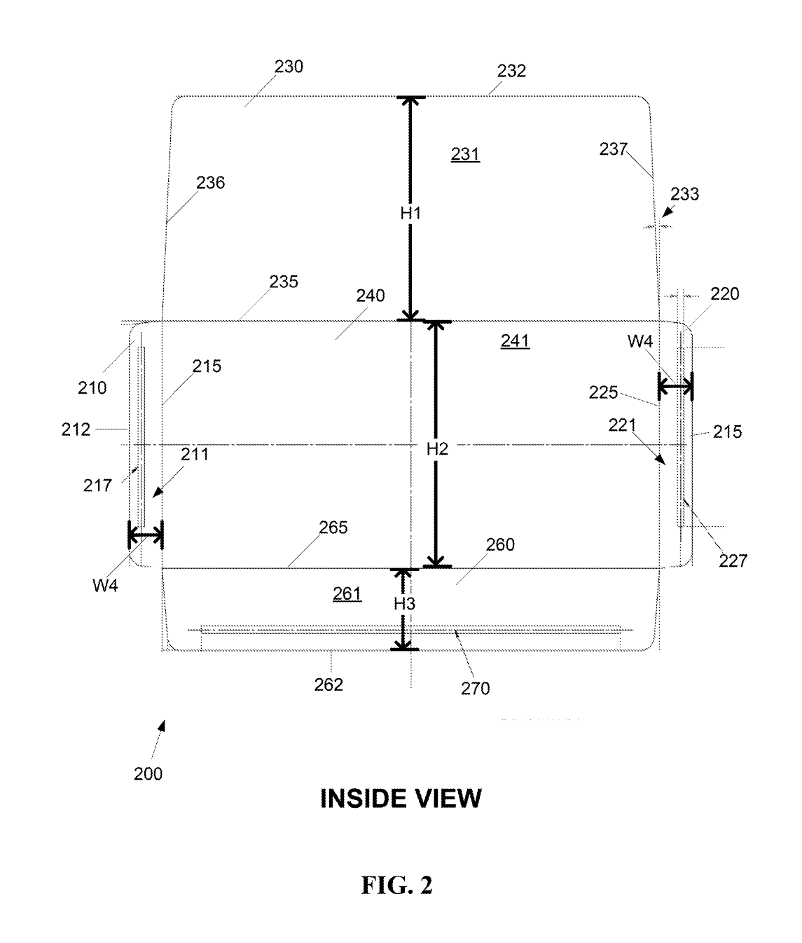

FIG. 2 shows an inside view of the first embodiment of the envelope form 200. The envelope form 200 may formed from a single sheet of paper or cardboard, having a first wing 210 foldable at a first side fold 215 and a second wing 220 foldable at a second side fold 225. The first wing 210 may extend to a first wing external edge 212, and the second wing 220 may extend to a second wing external edge 222. The first wing external edge 212 and the second wing external edge 222 may each be substantially straight lines until nearing a corner portion (the corner portions may be rounded, as shown or sharp corners). The first wing external edge 212 may be parallel to the second wing external edge 222 before and/or after folding.

The first wing 210 may include a first wing cohesive strip 217 applied to a first wing interior surface 211 of the first wing 210. Likewise, second wing 220 may include a second wing cohesive strip 227 applied to a second wing interior surface 221 of the second wing 220. The first wing 210 may have a first wing external edge 212.

A back panel 230 having a back panel interior surface 231 may be foldable at a bottom fold 235, so that the back panel interior surface 231 comes face-to-face with a front panel interior surface 241 of a front panel 240. The front panel 240 may optionally include a window (not shown), for example, to reveal text indicating an address printed upon a document within the envelope form 200.

A seal flap 260 extends outward from the front panel 240, and may be folded at a seal flap fold 265 such that a seal flap cohesive strip 270 of the seal flap 260 disposed on an interior surface of the seal flap 260 overlays the bottom flap 230 and/or the side wings 210, 220, after the back panel 230 has been folded against the front panel 240 and the side wings 210, 220 have been folded over the back panel 230, as described further below.

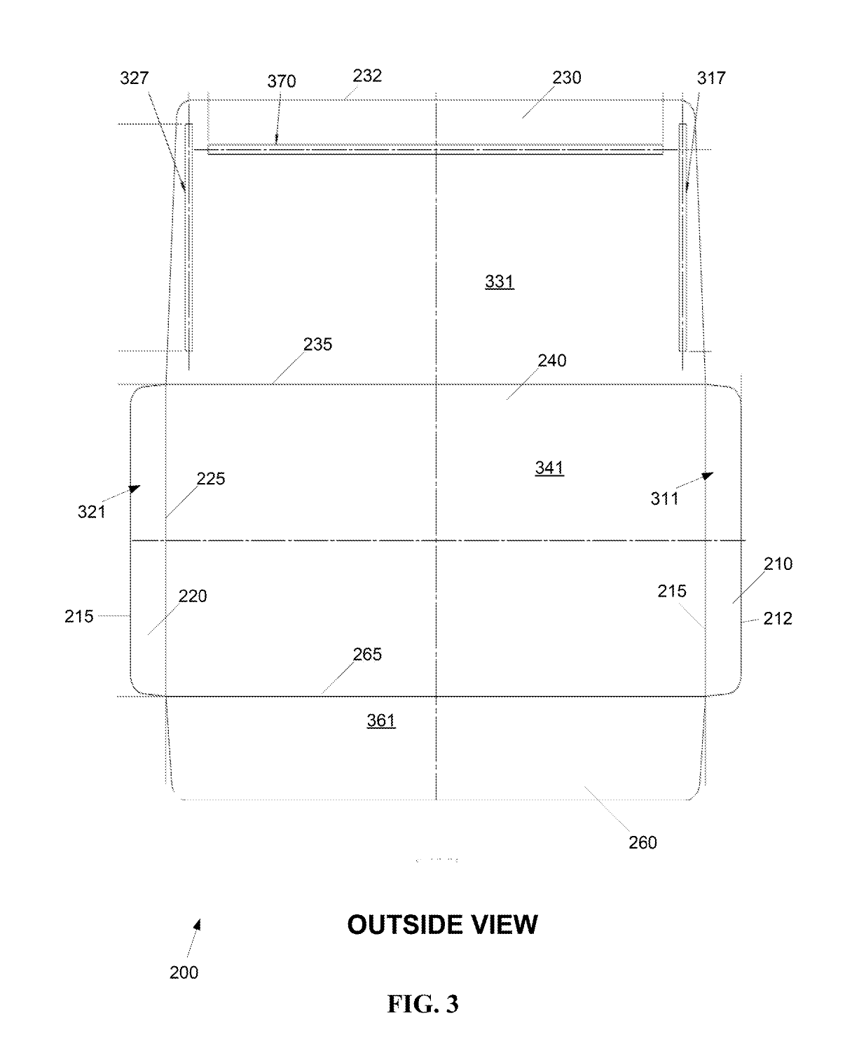

FIG. 3 shows an outside view of the first embodiment of the envelope form 200. A back panel exterior surface 331 is disposed opposite the back panel interior surface 231 (FIG. 2) of the back panel 230. The back panel exterior surface 331 may include a plurality of cohesive strips 370, 317, and 327 applied to the back panel exterior surface 331. For example, the cohesive strip material is applied to the form 200 as a hot liquid and dried, for example, with a ultra-violet drier.

In alternative embodiments, the plurality of cohesive strips 370, 317, and 327 may be contiguous. A back panel first wing cohesive strip 317 is positioned to be overlaid by the first wing cohesive strip 217 after the back panel 230 has been folded against the front panel 240 such that the back panel interior surface 231 is face-to-face with the front panel interior surface 241. It should be noted that when the envelope form 200 is folded, it may be folded around an envelope payload or insert (typically one or more folded documents), in which case the envelope payload may be disposed between the back panel interior surface 231 and the facing front panel interior surface 241.

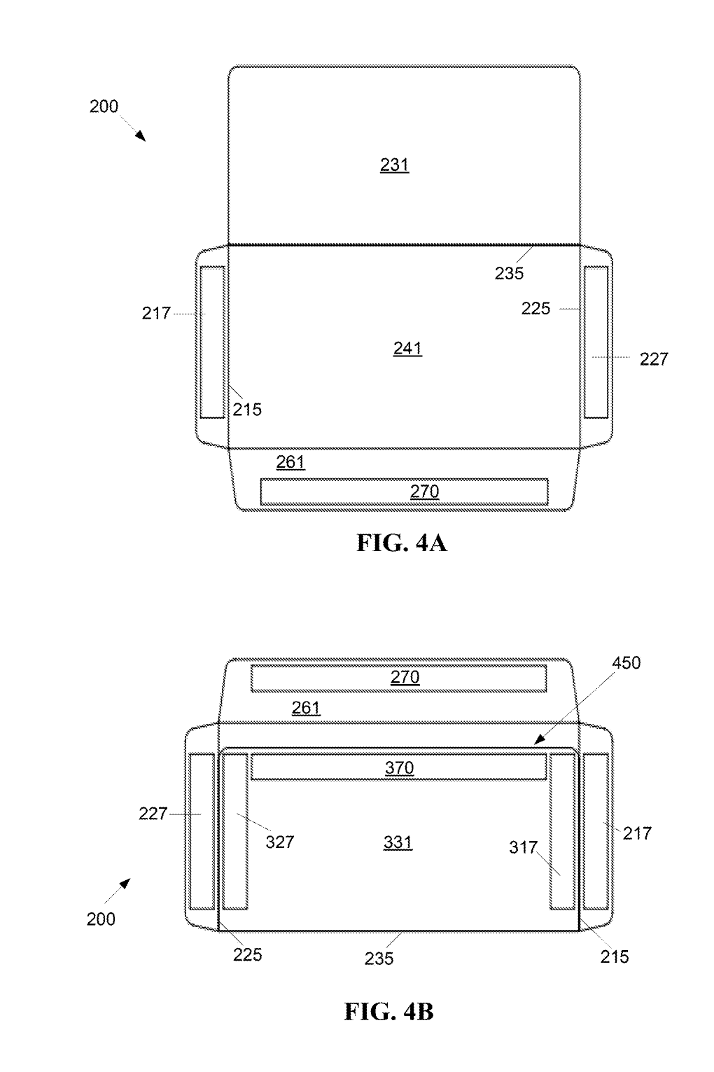

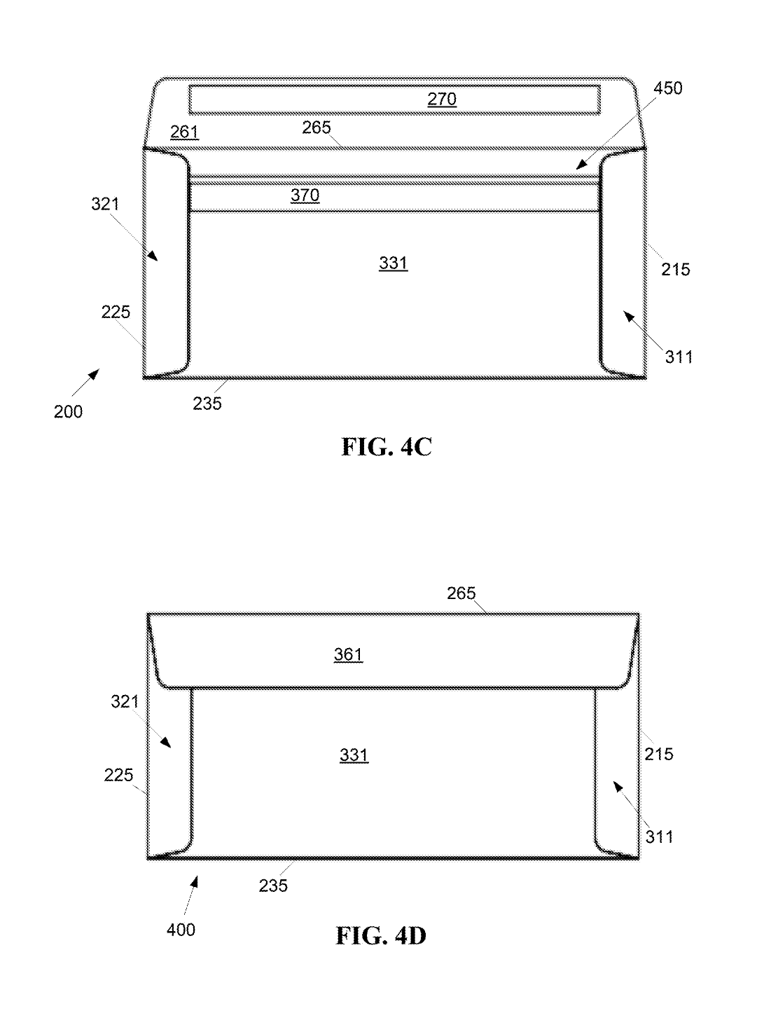

FIG. 4A shows a simplified drawing of the inside view of the envelope form 200 before any folding. FIG. 4B shows the envelope form 200 after a first folding has been performed along the bottom fold 235, such that the back panel 230 (FIG. 2) is folded against the front panel 240 (FIG. 2) resulting in the back panel interior surface 231 being face-to-face with the front panel interior surface 241. It should be noted that the image of the envelope form in FIG. 4B is inverted with respect to FIG. 4A. The first folding provides a first (bottom) edge to an interior pocket 450 of the envelope 400, corresponding to the bottom fold 235.

As can be seen in FIG. 4B, the first wing cohesive strip 217 is positioned to overlay and mate with the back panel first wing cohesive strip 317 when the first wing 210 (FIG. 2) is folded over the back panel exterior surface 331 as a result of a second folding along the first side fold 215. Similarly, the second wing cohesive strip 227 is positioned to overlay and mate with the back panel second wing cohesive strip 327 when the second wing 220 (FIG. 2) is folded over the back panel exterior surface 331 as a result of a third folding. It should be noted that the second and third folds may occur in reverse order, or at the same time.

FIG. 4C shows the envelope form 200 after the wings 210, 220 have been folded against the back panel exterior surface 331. The second folding provides a second (side) edge to the interior pocket of the envelope 400 along the first side fold 215, and the third fold provides a third (side) edge to the interior pocket of the envelope 400 along the second side fold 225. As shown in FIG. 4C, the interior pocket 450 of the partially formed envelope 400 is accessible via an opening or throat. However, it should be noted that preferably the envelope form 200 is folded around a payload that has been positioned against the front panel interior surface 241.

As can be seen in FIG. 4C, the seal flap cohesive strip 270 is positioned to overlay and mate with the back panel top cohesive strip 370 when the seal flap 260 (FIG. 2) is folded over the back panel exterior surface 331 as a result of a fourth folding along the seal flap fold 265. The fourth folding provides a fourth (top) edge to the interior pocket of the envelope 400 along the seal flap fold 265. The finished envelope 400 is fully formed as a result of the fourth folding, as shown by FIG. 4D.

The patterns/locations of the cohesive strips 217, 227, 270, 317, 327, 370 for the envelope 400 are different than any previous envelopes, for example, envelopes using side seam blue, where typically the wings 210, 220 are on the inside not outside of the back panel 230 (FIG. 2), where the previous envelopes may impede the folding/insertion workflow proceeding from an incomplete envelope form to a ready mail piece (the envelope 400 formed around the payload).

Each of the folds 215, 225, 235, and 265 may be physically prepared to facilitate folding, for example, by crimping, creasing, perforating, or other means along the folds 215, 225, 235, and 265, thereby assisting a folding mechanism to ensure the folding occurs at the desired location on the envelope form 200.

Returning to FIG. 2, the dimensions of the envelope form 200 may be varied for specific applications. In general, these dimensions rely on the range of payloads or inserts to be sealed within the finished envelope 400 (FIG. 4D). For example, the front panel 240 may be the shape and the size of the front panel 240, which may generally be based on the size of the largest surface area of the insert, typically a folded document.

The back panel 230 has a first height H1 at the bottom fold 235 that may correspond to a second height H2 of the front panel 240. A width of the back panel 230 may taper at a taper angle 233 with respect to a second width at a back panel edge 232. Alternatively, the back panel sides 236, 237 may not be straight, may have a plurality of straight segments, may be curved, or may have a combination of straight and curved segments. The height H1 of the back panel 230, roughly defined as a distance between and perpendicular to the bottom fold 235 and the back panel edge 232, may vary depending upon a desired thickness of the envelope 400. For example, a thicker envelope 400 may have a greater height H1 of the back panel 230 so the back panel has more material to wrap over the insert/payload.

The seal flap 260 has a first width at the seal flap fold 265 that corresponds to a width of the front panel 240. A width of the seal flap may taper at to a second width at a seal flap edge 262. Like the height H1 of the back panel 230, a height H3 of the seal flap 260, defined as a distance between the seal flap fold 265 and the seal flap edge 262, may vary depending upon a desired thickness of the envelope 400. In general, the height H1 of the back panel 230 may be greater than the height H3 of the seal flap 260.

The second height H2 of the front panel 240 may be measured between the bottom fold 235 and the seal flap fold 265. The height H1 of the back panel 230 may be similar to the height H2 of the front panel 240 so that the back panel 230 may fully cover a thin insert. For thick inserts, it may be desirable that the height H1 of the back panel 230 be equal to or greater than the height H2 of the front panel 240 so that when folded over to cover the insert, the back panel 230 extends sufficiently far to overlap with the folded seal flap 260.

The back panel edge 232 may preferably be parallel to the bottom fold 235, the seal flap edge 262 may be parallel to the seal flap fold, and the bottom fold 235 may be parallel to the seal flap fold. The back panel edge 232 and the seal flap edge 262 may preferably be parallel to one another before and/or after folding.

The back panel edge 232 and the seal flap edge 262 may preferably be perpendicular to the first wing external edge 212 and the second wing external edge 222 before and/or after folding. The first wing external edge 212 may be parallel to the first side fold 215, and the second wing external edge 222 may be parallel to the second side fold 225.

The size, shape, and positioning of the seal flap cohesive strip 270 on the seal flap interior surface 261 and the back panel top cohesive strip 370 on the back panel exterior surface 331 may be adjusted according to the dimensions of the insert, such that at least a portion of the seal flap cohesive strip 270 overlaps with the back panel top cohesive strip 370 when the envelope form 200 is folded over the insert. For example, the shape, and size of the seal flap cohesive strip 270 may be larger or smaller than the back panel top cohesive strip 370 to accommodate payloads having a range of widths, so that preferably at least a portion of the seal flap cohesive strip 270 and the back panel top cohesive strip 370 overlap when sealed around a payload having a minimum thickness (for example, an empty payload), to a maximum thickness corresponding to a maximum payload capacity. Depending upon the application, the size, shape and positioning of the cohesive strips 270, 370 may be chosen to accommodate a maximum thickness of the payload of up to one half inch, one inch, or more.

Likewise, the size and shape of the wings 210, 220 and the size, shape, and positioning of the first wing cohesive strip 217 and the second wing cohesive strip 227 may be adjusted according the desired insert size so that the first wing cohesive strip 217 at least partially overlaps the back panel first wing cohesive strip 317 and the second wing cohesive strip 227 at least partially overlaps the back panel second wing cohesive strip 327 when the envelope form 200 is folded over the insert.

In general, the front panel may have a width ranging from approximately 3 inches to 12 inches, and a height H2 ranging from 3 inches to 15 inches although larger and smaller dimensions are also possible. The envelope form 200 may be sized to accommodate an insert having a thickness between 0 mm and 40 mm or more.

The envelope form 200 may be configured to be manipulated by a document processing machine that stages the envelope form 200 to receive an insert, for example, a folded set of paper which may be a single sheet or multiple pages collated together. The document processing machine delivers the insert to the envelope form 200 and through a mechanical process that wraps the envelope form 200 around the insert to enclose the insert inside the envelope 400. The envelope 400 may then be sealed, for example, by passing the envelope through one or more rollers or set of rollers to activate the cohesive glue of the cohesive strips 217, 317, 227, 327, 270, 370 and create a fully sealed and ready mail envelope 400.

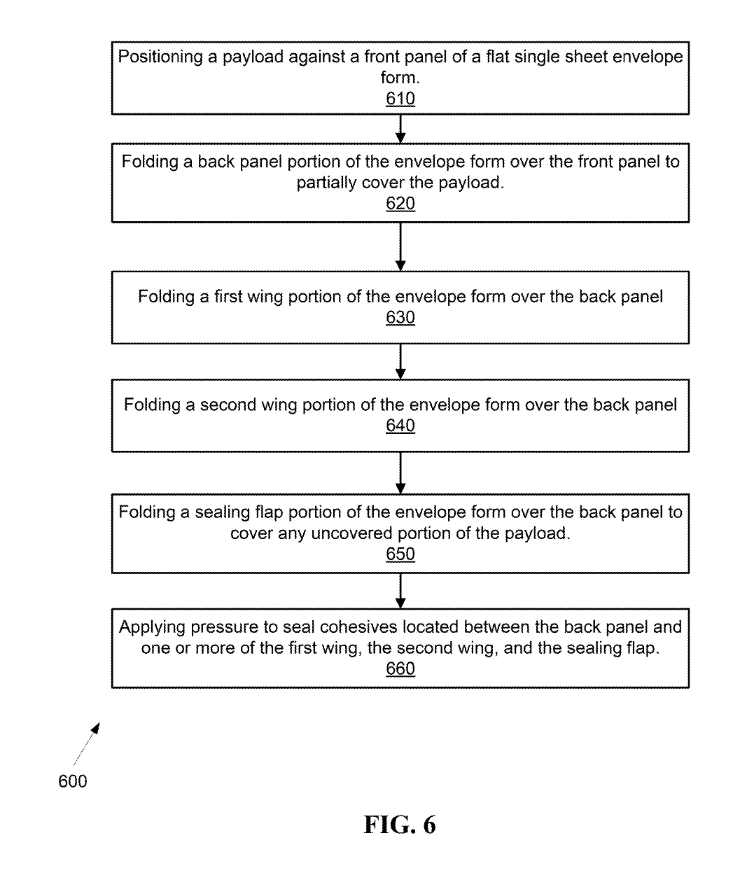

FIG. 6 is a flowchart of a method for using an envelope form. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The description of the method also refers to FIGS. 4A-4D.

A payload is positioned against a front panel interior surface 241 of a flat single sheet envelope form 200, as shown by block 610. A back panel exterior surface 331 of the envelope form 200 is folded over the front panel to partially cover the payload, as shown by block 620. A first wing portion 311 of the envelope form 200 is folded over the back panel exterior surface 331, as shown by block 630. A second wing portion 321 of the envelope form 200 is folded over the back panel exterior surface 331, as shown by block 640. A sealing flap portion 361 of the envelope form 200 is over the back panel exterior surface 331 to cover any uncovered portion of the payload, as shown by block 650. Pressure is applied to seal cohesive strips 217, 317, 227, 327, 270, 370 located between the back panel exterior surface 331 and one or more of the first wing portion 311, the second wing portion 321, and the sealing flap 361, as shown by block 660.

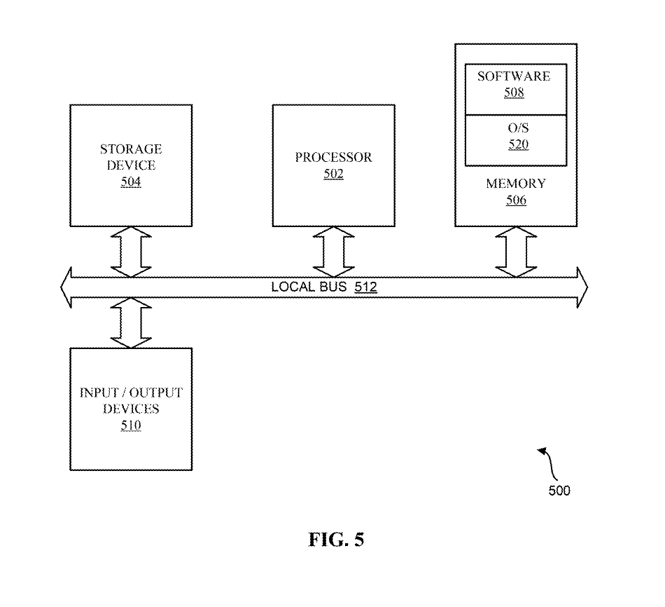

A system for controlling a device (machine) to perform the stuffing, folding, and sealing operations described above in detail may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. For example, in an alternative embodiment, the wings may have the cohesive strips on the exterior surface of the form, so that the wings are folded before the back panel, and the wing cohesive strips correspond to back panel cohesive strips on the interior of the back panel. While the cohesive strips 217, 317, 227, 327, 270, 370 have generally been depicted as being rectangular in shape, other shapes and configurations may be used to suit the dimensions and characteristics of the insert being wrapped. For example, the cohesive may be applied as a series of squares, dots, lines, or other shapes. As another example, the seal flap cohesive strip 270 may be implemented as two or more shorter strips positioned end-wise, as two or more long strips positioned parallel to one another.

In view of the foregoing, it is intended that the present invention cover modifications and variations of this invention provided they fall within the scope of the following claims and their equivalents.

What is claimed is:

1. A flat mailing envelope form for encapsulating an insert by an automated paper folding machine, comprising:
a rectangular front panel comprising a seal flap fold edge, a bottom fold edge opposite the seal flap fold edge, a first side fold edge spanning between the seal flap fold edge and the bottom fold edge, and a second side fold edge opposite the first side edge spanning between the seal flap fold edge and the bottom edge;
a back panel extending from the front panel bottom fold edge and bounded by a back panel edge, a back panel first side edge and a back panel second side edge comprising, a back panel seal cohesive region, a first wing cohesive region, and a second wing cohesive region;
a seal flap extending from the front panel seal flap fold edge and bounded by a seal flap panel edge, a seal flap first side edge and a seal flap second side edge comprising a seal flap cohesive region configured to mate with the back panel seal cohesive region;
a first wing extending from the first side fold edge comprising a first wing cohesive region configured to mate with the back panel first wing cohesive region; and
a second wing extending from the second side fold edge comprising a second wing cohesive region configured to mate with the back panel second wing cohesive region.

2. The envelope form of claim 1, wherein the front panel bottom fold edge is substantially parallel to the back panel edge, and the seal flap fold edge is substantially parallel to the seal flap edge.

3. The envelope form of claim 1, further comprising fold facilitating means along at least one of the seal flap fold edge, the bottom fold edge, the first side fold edge and the second side fold edge to facilitate folding along the respective edge.

4. The envelope form of claim 1, wherein at least one of the group consisting of the back panel seal cohesive region, the first wing cohesive region, the second wing cohesive region, the seal flap cohesive region, and the first wing cohesive region the second wing cohesive region further comprises a cohesive adhesive.

5. The envelope form of claim 1, wherein each of the group consisting of the back panel seal cohesive region, the first wing cohesive region, the second wing cohesive region, the seal flap cohesive region, and the first wing cohesive region the second wing cohesive region further comprises a cohesive adhesive.

6. The envelope form of claim 1, wherein the front panel further comprises a window configured to reveal an address field of the insert.

7. The envelope form of claim 1, wherein the rectangular front panel, the back panel, the seal flap, the first and the second wing comprise a single contiguous sheet of envelope stock material.

8. The envelope form of claim 1, wherein a first height comprising a distance between the back panel edge and the bottom fold edge is substantially the same as or greater than a second height comprising a distance between the bottom fold edge and the seal flap fold edge.

9. The envelope form of claim 8, wherein a width of the first wing is substantially equal to a width of the second wing, the width of the first and/or second wing is less than the first height, and the width of the first and/or second wing is less than the first height.

10. The envelope form of claim 1, wherein the first wing cohesive region is disposed on an inwardly folding portion of the first wing configured to mate with the back panel first wing cohesive region located on the exterior portion of the back panel, the second wing cohesive region is disposed on an inwardly folding portion of the second wing configured to mate with the back panel second wing cohesive region located on the exterior portion of the back panel.

11. A method for enclosing an insert with an envelope form by an automated paper folding machine, comprising the steps of:
receiving a payload against a front panel of a flat single sheet envelope form;
folding a back panel portion of the envelope form over the front panel to partially cover the payload;
folding a first wing portion of the envelope form over the back panel;
folding a second wing portion of the envelope form over the back panel;
folding a sealing flap portion of the envelope form over the back panel to cover any uncovered portion of the payload; and
applying pressure to seal one or more cohesive regions located between the back panel and one or more of the first wing, the second wing, and the sealing flap.

12. The method of claim 11, wherein applying pressure to seal one or more cohesive regions further comprises rolling a cylindrical roller over the one or more cohesive regions.
